(19) United States
(12) Patent Application Publication
(10) Pub. No.: US 2024/0094004 A1
(43) Pub. Date: Mar. 21, 2024

(54) SYSTEM AND METHOD FOR DETERMINING GEOLOCATION DATA

(71) Applicant: ELEMENT SIX TECHNOLOGIES LIMITED, Didcot, Oxfordshire (GB)

(72) Inventors: Andrew Mark Edmonds, Didcot (GB); Matthew Lee Markham, Didcot (GB)

(73) Assignee: ELEMENT SIX TECHNOLOGIES LIMITED, Didcot, Oxfordshire (GB)

(21) Appl. No.: 17/766,883

(22) PCT Filed: Dec. 15, 2020
(86) PCT No.: PCT/EP2020/086310

§ 371 Date: Apr. 6, 2022

(30) Foreign Application Priority Data
Dec. 17, 2019 (GB) 1918634.5

(51) Int. Cl. G01C 21/20; G01S 5/16

(52) U.S. Cl. CPC G01C 21/206; G01S 5/16

(57) ABSTRACT

A system and sensor device for determining geolocation data. A plurality of nodes, each at a predetermined location is provided. Each node emits a time-varying magnetic field, each time-varying magnetic field having a characteristic identifying the node. A sensor device comprises a magnetometer, the magnetometer configured to detect the time-varying magnetic field from at least one of the plurality of nodes, the magnetometer comprising diamond comprising at least one quantum spin defect. The sensor device has a processor configured to determine the identifying characteristic from the sensed time-varying magnetic field, and is further configured to determine geolocation data on the basis of at least the determined identifying characteristic.

### FIELD

The present invention relates to the field of determining geolocation data, and in particular to determining geolocation data using a magnetometer comprising a diamond sensor with a quantum spin defect and a plurality of fixed nodes emitting a time-varying magnetic field.

### BACKGROUND

Interest in being able to locate the position of a moving object or person within an indoor environment has increased greatly in recent years. For the user of smart-phones it would be desirable to emulate the existing accuracy and quality of outdoor mapping and geo-location with the ability to know their position accurately within complex indoor environments such as a shopping mall, warehouse or airport. With the improvement in drone technology and semi-autonomous robots, there is also the interesting question as to whether such objects could follow paths and navigate within an indoor environment. In the case of drones, there is increasing interest in package delivery and stock-picking by ground-based drones or unmanned aerial vehicles (UAVs). Navigating to a building is possible using outdoor navigation, but problems still exist with indoor navigation.

Outdoor navigation is relatively straightforward using current technology owing to the availability and accuracy of GPS. However, this is inaccessible for indoor locations, as a line-of-sight to geostationary satellites is required. Some solutions already exist for indoor navigation. The first of these is the use of Wi-Fi hotspots to build up a fingerprint of power and availability of hotspots throughout an indoor environment. However, this has low positioning performance and has a high effort in terms of constructing and maintaining the database. A third-party vendor (such as a delivery company) must also have access to such information to navigate successfully. A common solution is the use of a narrow-band radio frequency (RF) signals such as Bluetooth Low Energy (BLE) where specific masts are set up to act as a “beacon”. This class of positioning systems is based on proximity algorithms and received-signal-strength, which limits their accuracy.

There has also been discussion in literature in using a building's “natural” B-field fingerprint, which comes about due the use of steel girders in modern construction (for example, Haverinen et al, Global indoor self-localization based on the ambient magnetic field, Robotics ad Autonomous Systems 57 (2009) 1028-1035). Objects may also give rise to their own B-field. Individual rooms can be identified and navigation has been demonstrated. However, the profile in an indoor environment is likely to change over time and, as with the use of Wi-Fi and BLE, a database has to be maintained and accessible to all vendors wishing to navigate successfully within that environment.

### SUMMARY

It is an object to provide a geolocation system that can be used to assist with indoor navigation.

According to a first aspect, there is provided a system for determining geolocation data. The system comprises a plurality of nodes, each node at a predetermined location, each node emitting a time-varying magnetic field, each time-varying magnetic field having a characteristic identifying the node. A sensor device is also provided, the sensor device comprising a magnetometer. The magnetometer is configured to detect the time-varying magnetic field from at least one of the plurality of nodes, the magnetometer comprising diamond comprising at least one quantum spin defect. The sensor device further comprises a processor configured to determine the identifying characteristic from the sensed time-varying magnetic field. The processor is further configured to determine geolocation data on the basis of at least the determined identifying characteristic.

As an option, the quantum spin defect comprises any of a nitrogen-containing defect, a silicon-containing defect, a nickel-containing defect, and a chromium-containing defect. As a further option, the quantum spin defect is a negatively-charged nitrogen-vacancy (NV⁻) defect.

Examples of identifying characteristics include any of frequency, strength, and encoded data.

The processor is optionally configured to determine geolocation data using at least the determined identifying characteristics from at least two of the plurality of nodes. As a further option, the processor is configured to determine geolocation data by triangulating information derived from the at least two identifying characteristics.

The processor is further configured to determine geolocation data using any of magnetic field vector information and magnetic field strength.

In order to refine the geolocation data and provide more accurate information, the processor is optionally further configured to determine geolocation data using further information selected from any of data derived from Wi-Fi signals, Global Position System data, data derived from Bluetooth signals, data derived from ambient magnetic fields, and data derived from digital imaging.

As an option, at least one of the plurality of nodes is located in an indoor location. This is particularly advantageous where other form of geolocation data, such as GPS, are not available.

The processor is optionally further configured to determine navigation information using at least the determined identifying characteristic. In other words, once geolocation data has been determined on the basis of the identifying characteristic, the processor can determine navigation data to inform a drone or other device making use of the data about navigation decisions.

As an option, the processor is configured to derive further navigation information from the determined geolocation data. For example, the geolocation data may include coordinates, and the further navigation information is derived on the basis of the coordinates.

As an option, the further navigation information is further derived from a database comprising any of a set of navigation instructions, and map information.

According to a second aspect, there is provided a sensor device configured for use in a system for determining geolocation data. The sensor device comprising a magnetometer configured to detect a time-varying magnetic field emitted from at least one node, the time-varying magnetic field having a characteristic identifying the node, the magnetometer comprising diamond comprising at least one quantum spin defect. The processor is configured to determine geolocation data on the basis of at least the determined identifying characteristic.

The quantum spin defect optionally comprises any of a nitrogen-containing defect, a silicon-containing defect, a nickel-containing defect, and a chromium-containing defect. As a further option, the quantum spin defect is a negatively-charged nitrogen vacancy (NV⁻) defect.

The processor is optionally configured to determine geolocation data using the identifying characteristic comprising any of frequency, strength, and encoded data.

As an option, the processor is configured to determine geolocation data using at least the determined identifying characteristics from at least two nodes, each node emitting a time-varying magnetic field having a characteristic identifying the node. As a further option, the processor is configured to determine geolocation data by triangulating information derived from the at least two nodes.

The processor is optionally further configured to determine geolocation data using any of magnetic field vector information, magnetic field strength.

As an option, the processor is further configured to determine geolocation data using further information selected from any of data derived from Wi-Fi signals, Global Position System data, data derived from Bluetooth signals, data derived from ambient magnetic fields, and data derived from digital imaging.

The processor is optionally further configured to determine navigation information using at least the determined identifying characteristic.

As an option, the processor is further configured to derive further navigation information from the determined geolocation data. Further navigation information is optionally further derived from a database comprising any of a set of navigation instructions, and map information.

The sensor device optionally comprises an output device, the output device configured to send the navigation information to a drone control system.

According to a third aspect, there is provided a drone comprising the sensor device as described above in the second aspect.

### BRIEF DESCRIPTION OF DRAWINGS

Non-limiting embodiments will now be described by way of example and with reference to the accompanying drawings in which:

FIG. 1 illustrates schematically an exemplary system for determining geolocation data;

FIG. 2 illustrates schematically an exemplary sensor device; and

FIG. 3 is a flow diagram showing exemplary steps.

### DETAILED DESCRIPTION

WO 2009/073736 describes a magnetometer for sensing a magnetic field that includes a solid-state electronic spin system, and a detector. The solid-state electronic spin system contains one or more electronic spin defects that are disposed within a solid-state lattice. An example of such a spin defect is an NV⁻ centre in diamond. The electronic-spin defects are be configured to receive optical excitation radiation and to align with the magnetic field in response thereto. The electronic spins defects may be further induced to precess about the magnetic field to be sensed, in response to an external control such as an RF field, the frequency of the spin precession being linearly related to the magnetic field by the Zeeman shift of the electronic spin energy levels. The detector may be configured to detect output optical radiation from the electronic spin, so as to determine the Zeeman shift and thus the magnetic field.

Other modes of use of a magnetometer can be used, for example, the Photocurrent Detection of Magnetic Resonance (PDMR) described in Bourgeois et al, Photoelectric detection of electron spin resonance of nitrogen-vacancy centres in diamond. Nature Communications. 6. 10.1038/ncomms9577.

The present invention exploits the vector and high-sensitivity (AC) capabilities of the electronic spin defects such as the NV⁻ centre in diamond, combined with the installation of a number of magnetic field nodes, which generate a time-varying or modulated magnetic field within an environment such as an indoor environment. The frequency of the generated magnetic field by the nodes can vary and encode additional geolocation or navigation information (such as route-finding information), following a pre-determined protocol) to provide a path for drones to follow without a priori knowledge of the environment (magnetic or otherwise). The term ‘drone’ is used herein to refer to any autonomous vehicle that navigates an environment. An example of a drone is a UAV, but a drone may be a ground-based wheeled or tracked vehicle. For example, the invention may be incorporated into an indoor environment such as a warehouse, where a drone is used for picking or delivering stock.

The use of a vector magnetometer allows a sensor device to estimate distance from the magnetic node by the magnitude of the magnetic field and the bearing to the target to be measured by the separate measurement of Bx, By and Bz. The signals from separate nodes can be discriminated due to their different identifying characteristics, such as frequency. A sensor device can thereby determine geolocation data on the basis of the detected magnetic field. The sensor device can also provide navigation information, which gives the drone pathfinding capabilities (e.g. travel to position 1, followed by position 2, etc.).

The nitrogen-vacancy (NV) defect in diamond is well established as being able to provide a sensitive measurement of a vector magnetic field through use of a single sensor. The measurement of a magnetic-field through such a device is free from any requirement for calibration and has low-drift. This is also beneficial in a vector modality as there is not the issue of having three separate sensors that require calibration and may be drifting in different directions, limiting the accuracy of the resulting vector reconstruction. However, the skilled person will appreciate that other defects in diamond, such as silicon-containing defects, nickel-containing defects, and chromium-containing defects, may also be used as a magnetometer.

The sensitivity of a NV-based magnetometer is increased in the case of trying to detect a known frequency of time-varying magnetic field (a so called “AC” sensing scheme). This is due to the fact that detection schemes such as Hahn Echo, Carr-Purcell-Meiboom-Gill (CPMG) pulse sequences and XY8 dynamic decoupling sequences can be used, which remove DC and time-varying signals away from the frequency of interest, akin to lock-in-detection.

A node with an unvarying magnetic field could be positioned in a building and an NV-based magnetometer could use this to determine geolocation data in ideal conditions. However, such a system would be susceptible to interference due to the generation of magnetic fields by other objects in the environment. This may also vary over time. The nodes of the present invention therefore use a time-varying magnetic field (for example, at kHz frequencies), as this removes this potential for interference and also permits additional information to be encoded within the time-varying magnetic field. In a simple embodiment, the different magnetic field emitting nodes are set up to generated fixed frequencies that are unique, e.g. node 1 generates v1=10 kHz, node 2 generates v2=15 kHz, node 3 generates v3=20 kHz and so on. A sensor device can discriminate these frequencies, which act as identifying characteristics, and using the knowledge of where the node is, derive geolocation information.

A sensor device comprising an NV-based magnetometer may be constructed to perform vector-magnetic field measurements searching at a frequency at v1, quickly followed by v2, etc. This provides the opportunity to triangulate a position or provide the possibility to way-find, i.e. travel to position 1 followed by positon 2 which is an essential component to moving around an environment consisting of corridors and obstacles. On a larger scale, a protocol could be implemented whereby such frequencies are standardised to provide way-finding capabilities to anyone interested navigating within all environments following that protocol.

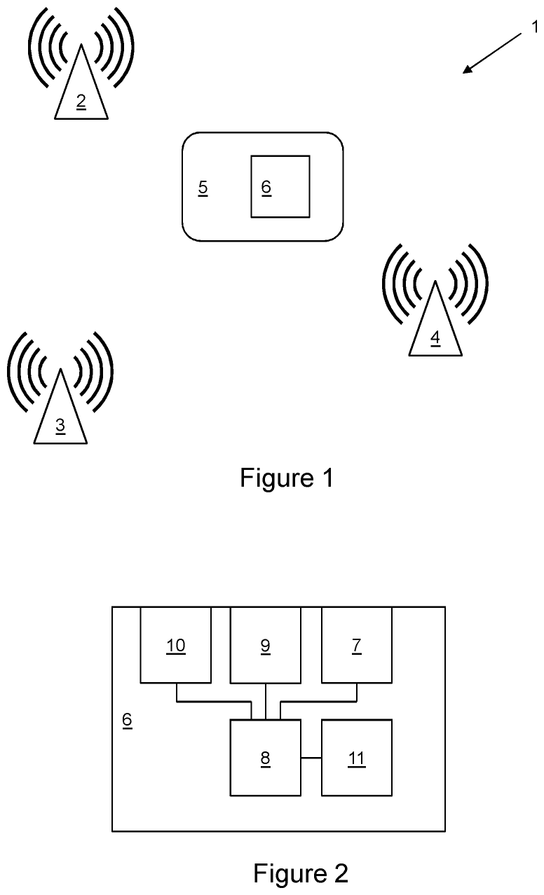

FIG. 1 herein illustrates schematically an exemplary system 1 for determining geolocation data. The system 1 includes a plurality of nodes 2, 3, 4, each node emitting a time-varying magnetic field that has a characteristic such as frequency, strength and/or encoded data that identifies the node and may provide further information.

A drone 5 is provided to navigate within the system 1. The drone includes a sensor device 6, which is configured to detect the time varying magnetic fields emitted by the various nodes and determine geolocation information on the basis of the detected time-varying magnetic fields

Turning now to FIG. 2, there is illustrated schematically an exemplary sensor device 6. The sensor device 6 is provided with a magnetometer 7 in the form of diamond containing at least one quantum-spin defect. In this example, the quantum-spin defect is a negatively-charged nitrogen-vacancy centre. A processor 8 is also provided, for proofing operations as described below.

In an optional embodiment, the sensor device 6 may be provided with a further source of data 9 that can be used by the processor 8 to determine geolocation data and/or navigation data. This may include data such as Wi-Fi signals, Global Position System data, data derived from Bluetooth signals, and data derived from digital imaging.

Where the processor 8 is configured to provide navigation information to the drone 5, an output device 10 is provided for passing navigation information to the control system of the drone 5.

A computer readable medium in the form of a memory 11 is also provided for storing information such as instructions and data to be used by the processor 8.

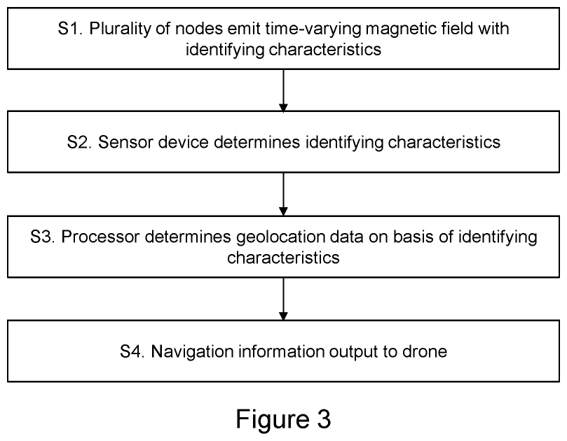

FIG. 3 is a flow diagram showing exemplary steps. The following numbering corresponds to that of FIG. 3:

S1. A plurality of nodes emit a time-varying magnetic field that includes information such as frequency, field strength and encoded data that uniquely identifies the node within the system 1. Encoded data may also include further information such as geolocation information, navigation information and so on. A set of standards may also be used to ensure that if the encoded data includes, for example, navigation data, then the same encoded data is always used for the same information (e.g. turn left, climb three metres, stop and so on)

As described above, at least one of the nodes may be located in an indoor location such as a warehouse, a hospital, an airport and so on, where geolocation data using GPS may be unavailable or inaccurate. It may be that all of the nodes are located in the indoor location. Note that the nodes may be located on different floors in the indoor location.

S2. A sensor device 6 includes a magnetometer 7 as described above which detects the time-varying magnetic field from a node. The processor 8 identifies the node from the identifying characteristic.

S3. The processor 8 determines geolocation data from the identifying characteristic.

The processor 8 may determine geolocation data from addition information. In a first example, geolocation data may be determined using the identifying characteristics of more than one node. For example, geolocation data may be determined by triangulating locations of more than one node. A database may be stored in the memory 11 that can assist the processor 8 in determining geolocation data. Information in the database may include a map of the area, locations of the nodes and their identifying characteristics and so on. The magnetometer can provide information such as magnetic field vector information and magnetic-field strength, which can be used by the processor 8.

As described above, the sensor device 6 may be provided with a further source of data 9 that can be used by the processor 8 to determine geolocation data and/or navigation data. This may include data such as Wi-Fi signals, Global Position System data, data derived from Bluetooth signals, and data derived from digital imaging.

Where Wi-Fi signals are used, the processor 8 is provided with access to a database of access points, and the location of each access point along with an identifying characteristic of the access point such as its IP address or MAC address. By identifying an access point, the processor 8 can refine further the geolocation data.

In some circumstances, all or part of the geographical areas 5 over which the drone 5 operates is in an outdoor area. In this case, line of sight is available to a geostationary satellite from which GPS data can be obtained. While the invention does not require GPS data to be implemented, GPS data can be used to supplement or refine the geolocation data determined by the processor. A drone 5 may, for example, rely on GPS data to obtain geolocation data where GPS data is available, and when GPS data is no longer available, for example when the drone 5 moves into an indoor environment, the drone 5 may switch to determining geolocation data from the plurality of nodes emitting a time-varying magnetic field.

Data derived from Bluetooth signals may also be used to determine geolocation data, For example, where a drone is navigating a hospital, it may detect Bluetooth signals from fixed equipment in the hospital and consult a database of identifying characteristics from the Bluetooth signals mapped to geographical locations of the devices having those Bluetooth identifying characteristics. This is used to refine or confirm geolocation data derived from the nodes.

Data derived from digital imaging is commonly used to assist in drone navigation. In this case, the drone 5 has computer-vision capabilities. This includes the ability to acquire, analyse and make sense of digital images. By understanding what the drone is ‘seeing’, the drone 5 can use this information to navigate. For example, the drone 5 may determine from its determined geolocation data that is needs to navigate to a next point (see step S4 below). However, a temporary obstacle may be in the way, and the digital image analysis can assist the drone 5 is navigating around this object. Furthermore, digital images may help the processor 8 to refine the geolocation data of the drone. For example, a predetermined image may be used to guide a drone 5 to a landing location.

As discussed above, it has been proposed to use ambient magnetic fields to determine geolocation data in an indoor area. The magnetometer 7 can also detect ambient magnetic fields. This can be compared with a database mapping ambient magnetic field data to locations to refine further the geolocation data determined from the identifying characteristics of the nodes.

S4. While the invention is concerned primarily with determining geolocation data, this data can be used to derive navigation instructions and provide them to the drone 5.

The processor 8 may determine navigation instructions using only the determined identifying characteristic. For example, if a certain node is detected then the navigation instructions tell the drone 5 to turn left, turn right, or stop and so on.

However, it may be more useful to determine navigation instructions using the geolocation data derived from the identifying characteristics. For example, the processor 8 determines that that the node 5 is in a certain location. This location data may be presented in the same way as GPS location data. Using a database of navigation instructions and/or map of the location, the navigation instructions can be derived.

Once the processor 8 has determined the navigation instructions, these are passed to the drone 5, which navigates in response to them.

While this invention has been particularly shown and described with reference to preferred embodiments, it will be understood to those skilled in the art that various changes in form and detail may be made without departing from the scope of the invention as defined by the appendant claims.

1. A system for determining geolocation data, the system comprising:
a plurality of nodes, each node at a predetermined location, each node emitting a time-varying magnetic field, each time-varying magnetic field having a characteristic identifying the node;
a sensor device, the sensor device comprising a magnetometer, the magnetometer configured to detect the time-varying magnetic field from at least one of the plurality of nodes, the magnetometer comprising diamond comprising at least one quantum spin defect; and
the sensor device further comprising a processor configured to determine the identifying characteristic from the sensed time-varying magnetic field, the processor being further configured to determine geolocation data on the basis of at least the determined identifying characteristic.

2. The system according to claim 1, wherein the quantum-spin defect comprises any of a nitrogen-containing defect, a silicon-containing defect, a nickel-containing defect, and chromium-containing defect.

3. The system according to claim 1, wherein the quantum spin defect is a negatively-charged nitrogen vacancy (NV⁻) defect.

4. The system according to claim 1, wherein the identifying characteristic comprises any of frequency, strength, and encoded data.

5. The system according to claim 1, wherein the processor is configured to determine geolocation data using at least the determined identifying characteristics from at least two of the plurality of nodes.

6. The system according to claim 5, wherein the processor is configured to determine geolocation data by triangulating information derived from the at least two identifying characteristics.

7. The system according to claim 1, wherein the processor is further configured to determine geolocation data using any of magnetic field vector information and magnetic-field strength.

8. The system according to claim 1, wherein the processor is further configured to determine geolocation data using further information selected from any of data derived from Wi-Fi signals, Global Position System data, data derived from Bluetooth signals, data derived from ambient magnetic fields, and data derived from digital imaging.

9. The system according to claim 1, wherein at least one of the plurality of nodes is located in an indoor location.

10. The system according to claim 1, wherein the processor is further configured to determine navigation information using at least the determined identifying characteristic.

11. The system according to claim 1, wherein the processor is further configured to derive further navigation information from the determined geolocation data.

12. The system according to claim 11, wherein the further navigation information is further derived from a database comprising any of a set of navigation instructions, and map information.

13. A sensor device configured for use in a system for determining geolocation data, the sensor device comprising:
a magnetometer configured to detect a time-varying magnetic field emitted from at least one node, the time-varying magnetic field having a characteristic identifying the node, the magnetometer comprising diamond comprising at least one quantum spin defect; and
a processor configured to determine geolocation data on the basis of at least the determined identifying characteristic.

14. The sensor device according to claim 13, wherein the quantum-spin defect comprises any of a nitrogen-containing defect, a silicon-containing defect, a nickel-containing defect, and a chromium-containing defect.

15. The sensor device according to claim 13, wherein the quantum spin defect is a negatively-charged nitrogen vacancy (NV⁻) defect.

16. The sensor device according to claim 13, wherein processor is configured to determine geolocation data using the identifying characteristic comprising any of frequency, strength, and encoded data.

17. The sensor device according to claim 13, wherein the processor is configured to determine geolocation data using at least the determined identifying characteristics from at least two nodes, each node emitting a time-varying magnetic field having a characteristic identifying the node.

18. The sensor device according to claim 17, wherein the processor is configured to determine geolocation data by triangulating information derived from the at least two nodes.

19. The sensor device according to claim 13, wherein the processor is further configured to determine geolocation data using any of magnetic-field vector information, magnetic-field strength.

20. The sensor device according to claim 13, wherein the processor is further configured to determine geolocation data using further information selected from any of data derived from Wi-Fi signals, Global Position System data, data derived from Bluetooth signals, data derived from ambient magnetic fields, and data derived from digital imaging.

21. The sensor device according to claim 13, wherein the processor is further configured to determine navigation information using at least the determined identifying characteristic.

22. The sensor device according to claim 21, wherein the processor is further configured to derive further navigation information from the determined geolocation data.

23. The sensor device according to claim 22, wherein the further navigation information is further derived from a database comprising any of a set of navigation instructions, and map information.

24. The sensor device according to claim 22, further comprising an output device, the output device configured to send the navigation information to a drone control system.

25. A drone comprising the sensor device according to claim 13.
